(19) United States
(12) Patent Application Publication
(10) Pub. No.: US 2026/0279657 A1
(43) Pub. Date: Sep. 17, 2026

(54) INDUCTOR MEMBER

(71) Applicant: NITTO DENKO CORPORATION, Osaka (JP)

(72) Inventors: Yoshihiro FURUKAWA, Osaka (JP); Keisuke OKUMURA, Osaka (JP); Hiroshi HIRANO, Osaka (JP)

(73) Assignee: NITTO DENKO CORPORATION, Osaka (JP)

(21) Appl. No.: 19/166,795

(22) PCT Filed: Mar. 12, 2024
(86) PCT No.: PCT/JP2024/009656

§ 371 Date: Sep. 18, 2025

(30) Foreign Application Priority Data
Mar. 22, 2023 (JP) 2023-045791

(51) Int. Cl. H01F 27/29; H01F 5/04; H01F 17/00

(52) U.S. Cl. CPC H01F 27/29; H01F 5/04; H01F 17/0013; H01F 2017/002; H01F 2017/0066

(57) ABSTRACT

An inductor member includes a magnetic layer, a plurality of interconnects disposed inside the magnetic layer and extending in a first direction, and a plurality of terminal pairs each including a first terminal part and a second terminal part, wherein at least two interconnects of the plurality interconnects are collinear along the first direction, and each of the at least two interconnects is connected to a corresponding pair of the plurality of terminal pairs.

### DESCRIPTION

### Technical Field

The disclosures herein relate to inductor members.

### Background Art

Inductor members are used as circuit elements mounted in various electronic devices. An inductor member including a plurality of interconnects and a sheet-shaped magnetic layer in which the plurality of interconnects are embedded is disclosed (see e.g., Patent Literature (PTL) 1).

### CITATION LIST

### Patent Literature

PTL 1: Japanese Laid-Open Patent Publication No. 2021-129105

### SUMMARY OF THE INVENTION

### Problem to be Solved By the Invention

The inductor member including the plurality of interconnects requires a space to arrange the interconnects inside the magnetic layer. Moreover, since electronic devices have been miniaturized, it is required to miniaturize inductor members.

The present disclosure aims to miniaturize an inductor member.

### Means of Solving the Problem

An inductor member includes a magnetic layer, a plurality of interconnects disposed inside the magnetic layer and extending in a first direction, and a plurality of terminal pairs each including a first terminal part and a second terminal part, wherein at least two interconnects of the plurality of interconnects are collinear along the first direction, and each of the at least two interconnects is connected to a corresponding pair of the plurality of terminal pairs.

### Effect of the Invention

According to the present disclosure, an inductor member can be miniaturized.

### BRIEF DESCRIPTION OF THE DRAWINGS

FIG. 1 is a plan view of an inductor member according to a first embodiment.

FIG. 2 is an A-A cross-sectional view of the inductor member according to the first embodiment.

FIG. 3 is a B-B cross-sectional view of the inductor member according to the first embodiment.

FIG. 4 is a cross-sectional view of a terminal part forming a terminal pair according to the first embodiment.

FIG. 5 is a plan view of the terminal part forming the terminal pair according to the first embodiment.

FIG. 6 is a plan view of a terminal part according to a modification of the first embodiment.

FIG. 7A is a schematic diagram illustrating an example of a method of manufacturing the inductor member according to the first embodiment.

FIG. 7B is a schematic diagram illustrating the example of the method £ of manufacturing the inductor member according to the first embodiment.

FIG. 7C is a schematic diagram illustrating the example of the method of manufacturing the inductor member according to the first embodiment.

FIG. 7D is a schematic diagram illustrating the example of the method of manufacturing the inductor member according to the first embodiment.

FIG. 7E is a schematic diagram illustrating the example of the method of manufacturing the inductor member according to the first embodiment.

FIG. 8 is a plan view of an inductor member according to a second embodiment.

FIG. 9 is a C-C cross-sectional view of the inductor member according to the second embodiment.

FIG. 10A is a plan view of an inductor member according to a third embodiment.

FIG. 10B is a plan view of the inductor member according to the third embodiment.

### DESCRIPTION OF THE PREFERRED EMBODIMENTS

In the following, embodiments of the present disclosure will be described with reference to the accompanying drawings. In the drawings, the same or corresponding constituent elements are denoted with the same reference numerals, and redundant description thereabout may be omitted.

The following embodiments exemplify an inductor member manufacturing method and the inductor member for embodying a technical idea of the present disclosure, and the present disclosure is not limited to the following embodiments. Dimensions, materials, shapes, relative arrangements, and the like of components described below are not intended to limit the scope of the present disclosure, but are intended to be exemplary, unless otherwise specified. In addition, a size, positional relationship, and the like of the components shown in the drawings may be exaggerated in order to clarify the description.

### First Embodiment

### <Structure of Inductor Member>

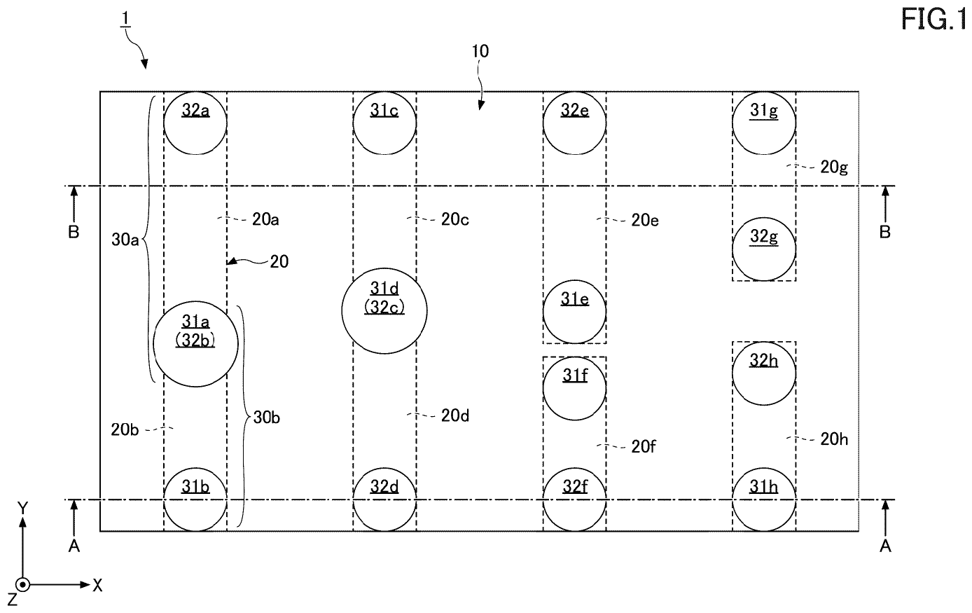

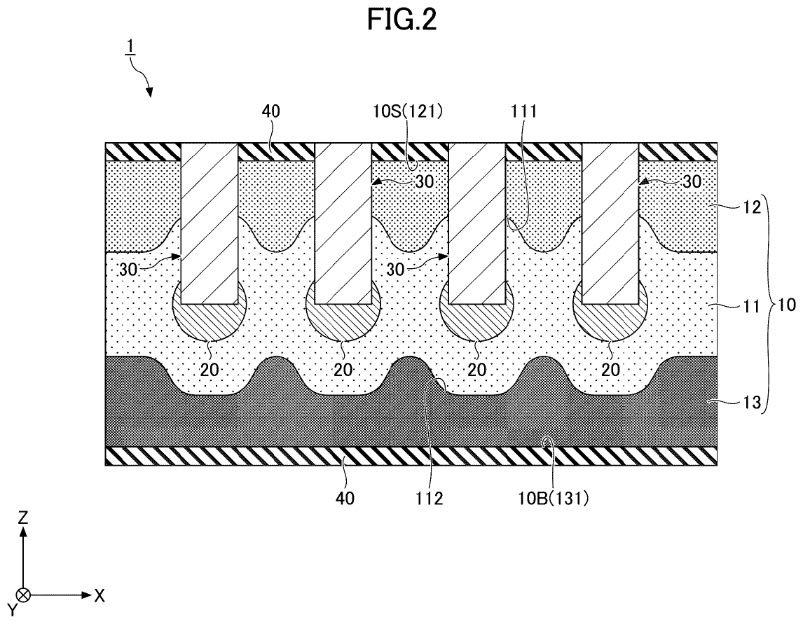

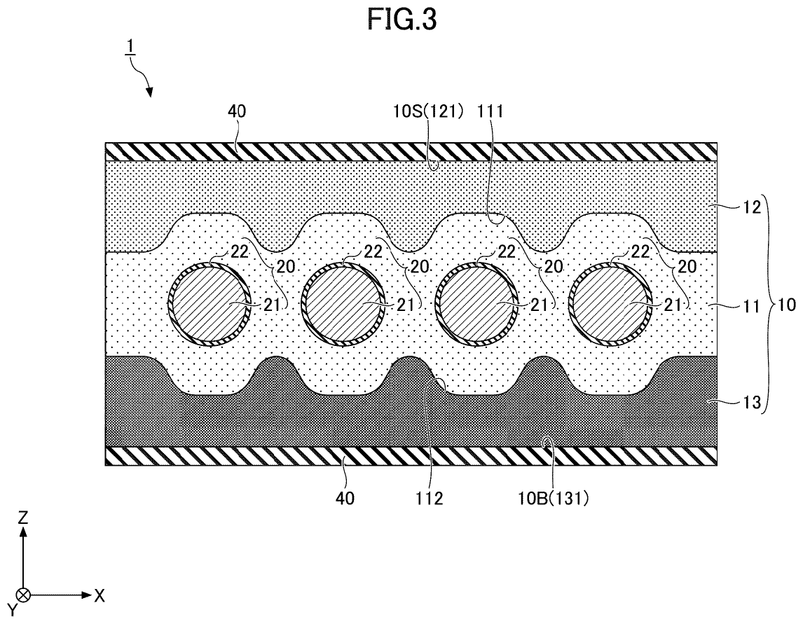

An overall structure of an inductor member 1 according to a first embodiment will be described with reference to FIGS. 1 to 3. FIG. 1 is a plan view of the inductor member 1. FIG. 2 is a cross-sectional view taken along an A-A line of FIG. 1. FIG. 3 is a cross-sectional view taken along a B-B line of FIG. 1.

Here, the illustrated X-direction corresponds to the width direction of the inductor member 1. The Y-direction corresponds to the horizontal depth direction of the inductor member 1. The Z-direction corresponds to the thickness direction of the inductor member 1. The X-direction and the Y-direction may be referred to as an “in-plane direction” of the inductor member 1. The Z-direction may be referred to as an “out-of-plane direction” of the inductor member 1. The X-direction, the Y-direction, and the Z-direction are mutually orthogonal. The Y-direction is an example of a “first direction”. The X-direction is an example of a “second direction”.

As shown in FIGS. 1 to 3, the inductor member 1 the first embodiment is a sheet-like member having a rectangular planar shape. More specifically, the inductor member 1 includes a magnetic laminate 10, a plurality of interconnects 20, a plurality of terminal pairs 30, and an insulating film 40. Here, the magnetic laminate 10 is an example of a “magnetic layer”. The insulating film 40 may be provided as needed.

### <Magnetic Laminate>

The magnetic laminate 10 will be described with reference to FIGS. 2 and 3. As shown in FIG. 2, the magnetic laminate 10 of the first embodiment has a sheet shape having a rectangular planar shape. The magnetic laminate 10 has a front surface 10S located on one side in the Z-direction and a back surface 10B located on the other side in the Z-direction. The front surface 10S and the back surface 10B of the magnetic laminate 10 are covered with the insulating film 40. The front surface 10S of the magnetic laminate 10 is an example of a “first surface” of the magnetic layer. The back surface 10B of the magnetic laminate 10 is an example of a “second surface” of the magnetic layer.

It is preferable that the magnetic laminate 10 include a plurality of magnetic layers in order to enhance an inductance value and a DC superposition characteristic. More specifically, the magnetic laminate 10 has a first magnetic layer 11, a second magnetic layer 12 disposed on one side of the first magnetic layer 11 in the Z-direction, and a third magnetic layer 13 disposed on the other side of the first magnetic layer 11 in the Z-direction. The first magnetic layer 11 is disposed between the second magnetic layer 12 and the third magnetic layer 13.

In the first embodiment, the second magnetic layer 12 corresponds to the uppermost layer of the magnetic laminate 10. Therefore, the front surface 10S of the magnetic laminate 10 corresponds to the front surface 121 located on one side of the second magnetic layer 12 in the Z-direction. The third magnetic layer 13 corresponds to the lowermost layer of the magnetic laminate 10. Therefore, the back surface 10B of the magnetic laminate 10 corresponds to the back surface 131 located on the other side of the third magnetic layer 13 in the Z-direction.

However, the magnetic laminate 10 does not necessarily include a plurality of magnetic layers. That is, the magnetic laminate 10 may consist, for example, of a monolayer structure including only the first magnetic layer 11.

### <<First Magnetic Layer>>

The first magnetic layer 11 has a predetermined thickness in the Z-direction and has a sheet-like form extending in the in-plane direction. A plurality of interconnects 20 are embedded in the first magnetic layer 11.

The first magnetic layer 11 includes magnetic particles and a binder holding the magnetic particles. Examples of shapes of the magnetic particles include an approximately spherical shape, an approximately needle shape, and an approximately flat shape, but are not limited thereto.

Examples of materials of the magnetic particles in the first magnetic layer 11 include soft magnetic materials and hard magnetic materials, but are not limited thereto. Among them, it is preferable to use soft magnetic materials in order to enhance the inductance value and the DC superposition characteristic of the inductor member 1.

Examples of soft magnetic materials include a single metal body containing one type of metallic element in a state of a pure substance, and an alloy body which is a eutectic body (mixture) of one or more types of metallic elements (first metallic element) and one or more types of metallic elements (second metallic element) and/or non-metallic elements (carbon, nitrogen, silicon, phosphorus, etc.). These materials can be used alone or in combination.

Examples of single metal bodies include a single metal material consisting of only one type of metallic element (first metallic element). Examples of first metallic elements include iron (Fe), cobalt (Co), nickel (Ni), and other metallic elements which can be contained as the first metallic element of the soft magnetic material.

Examples of single metal bodies include: a form including a core containing only one metallic element and a surface layer that includes an inorganic and/or organic substance modifying a part or entirety of the surface of the core; and a form obtained by decomposition (thermal decomposition, etc.) of an organometallic or inorganic metal compound containing a first metallic element. Examples of forms in which an organometallic or inorganic metal £ compound containing a first metal element is decomposed include iron powder (may be referred to as carbonyl iron powder) obtained by thermal decomposition of an organic iron compound (specifically, pentacarbonyl iron) containing iron as the first metal element. The position of the layer containing an inorganic and/or organic substance for modifying a portion including only one metallic element is not limited to the surface described above. An organometallic or inorganic metal compound for obtaining a single metal body is not particularly limited, and can be appropriately selected from any known or commonly used organometallic or inorganic metal compound capable of yielding a soft magnetic single metal body.

The alloy body is a eutectic mixture of one or more metallic elements (first metallic element) and one or more metallic elements (second metallic element) and/or non-metallic elements (carbon, nitrogen, silicon, phosphorus, etc.), and is not particularly limited as long as it can be used as an alloy body of a soft magnetic body.

The first metallic element is an essential element in the alloy body, such as iron (Fe), cobalt (Co), and nickel (Ni). Note that, when the first metallic element is Fe, the alloy body is considered as an Fe-based alloy, when the first metallic element is Co, the alloy body is considered as a Co-based alloy, and when the first metallic element is Ni, the alloy body is considered as a Ni-based alloy.

The second metallic element is an element (sub-component) secondarily contained in the alloy body and is a metallic element that is compatible (eutectic) with the first metallic element, such as iron (Fe) (when the first metallic element is other than Fe), cobalt (Co) (when the first metallic element is other than Co), nickel (Ni) (when the first metallic element is other than Ni), chromium (Cr), aluminum (Al), silicon (Si), copper (Cu), silver (Ag), manganese (Mn), calcium (Ca), barium (Ba), titanium (Ti), zirconium (Zr), hafnium (Hf), vanadium (V), niobium (Nb), tantalum (Ta), molybdenum (Mo), tungsten (W), ruthenium (Ru), rhodium (Rh), zinc (Zn), gallium (Ga), indium (In), germanium (Ge), tin (Sn), lead (Pb), scandium (Sc), yttrium (Y), strontium (Sr), and various rare earth elements. These elements can be used alone or in combination with two or more of them.

The non-metallic element is an element (sub-component) that is contained in the alloy body as a secondary component and is a non-metallic element that is compatible (eutectic) with the first metallic element, such as boron (B), carbon (C), nitrogen (N), silicon (Si), phosphorus (P), and sulfur (S). These elements can be used alone or in combination with two or more of them.

Examples of Fe-based alloys, which are a type of alloy body, include magnetic stainless steel (Fe—Cr—Al—Si alloy) (including electromagnetic stainless steel), Sendust (Fe—Si—Al alloy) (including Super Sendust), permalloy (Fe—Ni alloy), Fe—Ni—Mo alloy, Fe—Ni—Mo—Cu alloy, Fe—Ni—Co alloy, Fe—Cr alloy, Fe—Cr—Al alloy, Fe—Ni—Cr alloy, Fe—Ni—Cr—Si alloy, silicon copper (Fe—Cu—Si alloy), Fe—Si alloy, Fe—Si—B(—Cu—Nb) alloy, Fe—B—Si—Cr alloy, Fe—Si—Cr—Ni alloy, Fe—Si—Cr alloy, Fe—Si—Al—Ni—Cr alloy, Fe—Ni—Si—Co alloy, Fe—N alloy, Fe—C alloy, Fe—B alloy, Fe—P alloy, ferrite (including stainless ferrite and soft ferrite such as Mn—Mg ferrite, Mn—Zn ferrite, Ni—Zn ferrite, Ni—Zn—Cu ferrite, Cu—Zn ferrite, and Cu—Mg—Zn ferrite), permendur (Fe—Co alloy), Fe—Co—V alloy, and Fe-based amorphous alloy.

Examples of Co-based alloys, which are a type of alloy body, include Co—Ta—Zr and cobalt (Co)-based amorphous alloys. Examples of Ni-based alloys, which are a type of alloy body, include Ni—Cr alloys.

Examples of binders include a thermoplastic component such as an acrylic resin and a thermosetting component such as an epoxy resin composition. Examples of acrylic resins include a carboxyl group-containing acrylic ester copolymer. Examples of epoxy resin compositions include an epoxy resin (such as a cresol novolak type epoxy resin) as a main agent, a curing agent for the epoxy resin (such as a phenol resin), and a curing accelerator for the epoxy resin (such as an imidazole compound).

As the binder, the thermoplastic component and the thermosetting component can be used alone or in combination, and preferably, the thermoplastic component and the thermosetting component are used together.

The thickness of the first magnetic layer 11 is not particularly limited, but it is, for example, 100 μm or more, preferably 200 μm or more, and, for example, 2000 μm or less, preferably 1500 μm or less, and more preferably 1000 or less. Here, the thickness of the first magnetic layer 11 is a distance between the highest point on one surface 111 in the Z-direction and the lowest point on the opposite surface 112 in the Z-direction of the first magnetic layer 11.

As shown in FIGS. 2 and 3, in the first magnetic layer 11, regions immediately above and below the respective interconnects 20 are preferably raised according to the outer peripheral shape of the interconnects 20. More specifically, the region immediately above the interconnects 20 in the first magnetic layer 11 is preferably located to the upper part compared with the region between the interconnects 20. In the first magnetic layer 11, the region immediately below the interconnects 20 is preferably located to the lower part compared with the region between the interconnects 20.

Thus, compared with a case where the first magnetic layer 11 is flat, the first magnetic layer 11 can be formed along the magnetic field generated around each of the interconnects 20. Therefore, the inductance value can be increased more effectively. However, a form of the first magnetic layer 11 is not limited to this.

### <<Second Magnetic Layer and Third Magnetic Layer>>

The second magnetic layer 12 has a predetermined thickness and a sheet-like form extending in the in-plane direction. An insulating film 40 is disposed on the front surface 121 of the second magnetic layer 12. Like the first magnetic layer 11, the second magnetic layer 12 also includes magnetic particles and a binder.

The third magnetic layer 13 has a predetermined thickness and a sheet-like form extending in the in-plane direction. Like the first magnetic layer 11 and the second magnetic layer 12, the third magnetic layer 13 also includes magnetic particles and a binder. Examples of the magnetic particles of the second magnetic layer 12 and the third magnetic layer 13 include magnetic particles similar to the magnetic particles exemplified in the first magnetic layer 11. Examples of the binders of the second magnetic layer 12 and the third magnetic layer 13 include a binder similar to the binder exemplified in the first magnetic layer 11.

The second magnetic layer 12 preferably has a higher relative permeability than the first magnetic layer 11 by appropriately changing a type, shape, and the like of the magnetic particles. Thus, the inductance value of the inductor member 1 can be increased.

The third magnetic layer 13 preferably has a higher relative permeability than the first magnetic layer 11 by appropriately changing the type, shape, and the like, of the magnetic particles. Thus, the inductance value of the inductor member 1 can be increased.

When the magnetic particles of the first magnetic layer 11 have an isotropic shape such as an approximately spherical shape, for example, the magnetic particles of the second magnetic layer 12 and the third magnetic layer 13 preferably have an anisotropic shape such as an approximately flat shape.

### <Interconnect>

### <<Interconnect Arrangement>>

Next, the interconnect 20 will be described with reference to FIGS. 1 to 3. As shown in FIGS. 1 to 3, the plurality of interconnects 20 are arranged inside the magnetic laminate 10. Further, as shown by hidden lines (broken lines) in FIG. 1, each of the plurality of interconnects 20 extends along the Y-direction in plan view. Each of the plurality of interconnects 20 has, for example, an inductance value determined by the length of the corresponding interconnect 20.

Among the plurality of interconnects 20, at least two interconnects 20, such as interconnects 20a and 20b, are collinear along the Y-direction. Some of the interconnects 20, such as interconnects 20a and 20c, may be arranged at different positions in the X-direction. In a mode of FIG. 1, the different positions include the case where the interconnects are arranged apart in the X-direction. The number of interconnects 20 shown in the figure is eight, interconnects 20a to 20h, but is not limited thereto.

Each of the interconnects 20 is electrically connected to one terminal pair 30. In other words, each of the interconnects 20 is electrically connected to both of the first terminal part 31 and the second terminal part 32 forming the terminal pair 30. For example, the interconnect 20a is connected to the terminal pair 30a, and the interconnect 20b is connected to the terminal pair 30b.

In the present description, a term “interconnect” refers to a region corresponding to a path of a current input from one of the first terminal part 31 or the second terminal part 32 of one terminal pair 30 connected to a conductor, and output from the other, within a single conductor such as a linear conductor or a strip line. For example, both of the interconnect 20a and the interconnect 20b share a single conductor (for example, conducting core 21 of FIG. 3) extending in the Y-direction and are identical in appearance. However, in one conductor (conducting core 21 in FIG. 3), the interconnect 20a corresponds to a region between the first terminal part 31a and the second terminal part 32a of the terminal pair 30a, and the interconnect 20b corresponds to a region between the first terminal part 31b and the second terminal part 32b of the terminal pair 30b.

The interconnect 20a and the interconnect 20b are physically connected to each other. Therefore, the first terminal part 31a of the terminal pair 30a connected to the interconnect 20a and the second terminal part 32b of the terminal pair 30b connected to the interconnect 20b form a single terminal part.

Each of the plurality of interconnects 20 has, for example, an inductance value H determined by the length of the corresponding interconnect 20. For example, an inductance value H1 of the interconnect 20a corresponds to the length of the interconnect 20a. An inductance value H2 of the interconnect 20b corresponds to the length of the interconnect 20b. As shown in FIG. 1, the interconnect 20a is longer than the interconnect 20b. Therefore, the inductance value H1 is larger than the inductance value H2.

Conversely, when the lengths of the two interconnects 20 collinear along the Y-direction, such as the interconnect 20c and the interconnect 20d, are the same, an inductance value H3 corresponding to the length of the interconnect 20c and an inductance value H4 corresponding to the length of the interconnect 20d are substantially the same.

However, the number of interconnects 20 collinear along the Y-direction is not limited to two, and may be three or more. Further, the configuration is not limited to the case where interconnects 20 collinear along the Y-direction share the first terminal part 31a or the like, as in the interconnect 20a and the interconnect 20b, and the interconnect 20c and the interconnect 20d. Two or more interconnects 20 collinear along the Y-direction may also be spaced apart without sharing a terminal to be connected, as in the interconnect 20e and the interconnect 20f, and the interconnect 20g and the interconnect 20h. In this case, two or more interconnects 20 collinear along the Y-direction may be spaced apart, as in the interconnect 20e and the interconnect 20f, and the interconnect 20g and the interconnect 20h. Both of the interconnect 20e and the interconnect 20f, and both of the interconnect 20g and the interconnect 20h may share a conducting core (e.g., conducting core 21 in FIG. 3) extending in the Y-direction. A conducting core is not required to be continuous between the interconnect 20e and the interconnect 20f, and between the interconnect 20g and the interconnect 20h. In this case, the lengths of the interconnects 20 collinear along the Y-direction may be identical or different.

The interconnects 20 arranged at different positions in the X-direction are parallel to each other. Thus, the interconnects 20 can be arranged compactly, and the inductor member 1 can be miniaturized. However, this is not limited to this. The interconnects 20 arranged at different positions in the X-direction may be arranged at equal intervals or at different intervals. Furthermore, the lengths of the interconnects 20 arranged at different positions and opposite each other in the X-direction may be identical or different. In the inductor member 1 of the present application, for example, as shown in FIG. 2, a plurality of conducting cores 21 are arranged so as to be spaced apart in the X-direction, and each of the conducting cores 21 is arranged so as to extend from one side of the inductor member 1 to the other side along the Y-direction, and a plurality of interconnects 20 may be formed for each of the conducting cores 21.

Thus, by optimizing the arrangement of the interconnects 20, two or more interconnects 20 having identical or different inductance values H can be collinear along the Y-direction. In addition, a set of a plurality of interconnects 20 collinear along the Y-direction can be arranged in the X-direction. Thus, the plurality of interconnects 20 can be compactly arranged in the inductor member 1, and the inductor member 1 can be miniaturized.

The inductance values H of the plurality of interconnects 20 can be adjusted by changing the length of the interconnects 20. Therefore, the interconnects 20 having a desired inductance value H among the plurality of interconnects 20 can be suitably included in a circuit connected to the inductor member 1. Moreover, even if the circuit is designed to include a plurality of inductors, the circuit can include a plurality of interconnects 20 having inductance values H corresponding to respective inductors. As a result, according to the inductor member 1, the degree of freedom in designing the connected circuit can be increased.

### <<Interconnect Structure Details>>

Next, the structure of the interconnects 20 will be described. As shown in FIG. 3, each of the plurality of interconnects 20 has a circular shape in cross-sectional view. However, the cross-sectional shape of the interconnect 20 is not limited to a circular shape, and may be elliptical or polygonal. Further, although all of the interconnects 20 shown in the figure have substantially the same diameter, for example, some of the interconnects 20 may have a diameter different from that of the other interconnects 20.

More specifically, as shown in FIG. 3, the interconnect 20 has a conducting core 21 and an insulating film 22 covering the peripheral surface of the conducting core 21.

Examples of materials of the conducting core 21 include metal conductors such as copper, silver, gold, aluminum, nickel, and alloys thereof. Preferably, copper is used. The conducting core 21 may have a single-layer structure or a multi-layer structure in which the surface of the core conductor (e.g. copper) is plated (e.g., nickel). The conducting core 21 of the first embodiment is copper, but is not limited thereto.

The radius of the conducting core 21 is, for example, 25 μm or more, preferably 50 μm or more, and, for example, 2000 μm or less, preferably 200 μm or less.

The insulating film 22 protects the conducting core 21 from chemicals and water, and prevents short circuits between the conducting core 21 and the magnetic laminate 10 (first magnetic layer 11). The insulating film 22 covers the entire outer peripheral surface (circumferential surface) of the conducting core 21. The insulating film 22 has an approximately annular shape in cross-sectional view concentric with the interconnect 20.

Examples of materials of the insulating film 22 include insulating resins such as polyvinyl formal, polyester, polyester imide, polyamide (including nylon), polyimide, polyamide imide, and polyurethane. One of these materials may be used alone, or two or more of these materials may be used in combination. The insulating film 22 may be composed of a single layer or a plurality of layers.

The thickness of the insulating film 22 is substantially uniform in the radial direction of the interconnect 20, regardless of the circumferential position. For example, it is 1 μm or more, preferably 3 μm more, and, for example, 100 μm or less, preferably 50 μm or less. The ratio of the radius of the conducting core 21 to the thickness of the insulating film 22 is, for example, one or more, preferably five or more, and, for example, 500 or less, preferably 100 or less.

### <Terminal Pair>

### <<Terminal Pair Outline Configuration>

Next, the terminal pair 30 will be described with reference to FIGS. 1 to 3. As shown in FIG. 1, each of the plurality of terminal pairs 30 has a first terminal part 31 and a second terminal part 32. The terminal pair 30 is connected to the interconnect 20.

Although not particularly limited, the first terminal part 31 of the terminal pair 30 may function as an input terminal of a current supplied to the interconnect 20. In this case, the second terminal part 32 of the terminal pair 30 may function as an output terminal of the current supplied to the interconnect 20. Conversely, the first terminal part 31 of the terminal pair 30 may function as an output terminal of the current supplied to the interconnect 20. In this case, the second terminal part 32 of the terminal pair 30 may function as an input terminal of the current supplied to the interconnect 20.

As shown in FIG. 2, the first terminal part 31 and the second terminal part 32 of the terminal pair 30 are provided from the front surface 10S on one side in the Z-direction of the magnetic laminate 10 or the back surface 10B on the other side in the Z-direction toward the interconnect 20 in the magnetic laminate 10.

However, a formation surface of the first terminal part 31 and a formation surface of the second terminal part 32 in the magnetic laminate 10 are not limited thereto. For example, both the first terminal part 31 and the second terminal part 32 may be provided from either the front surface 10S or the back surface 10B of the magnetic laminate 10.

### <<Details of Terminal Pair Structure>

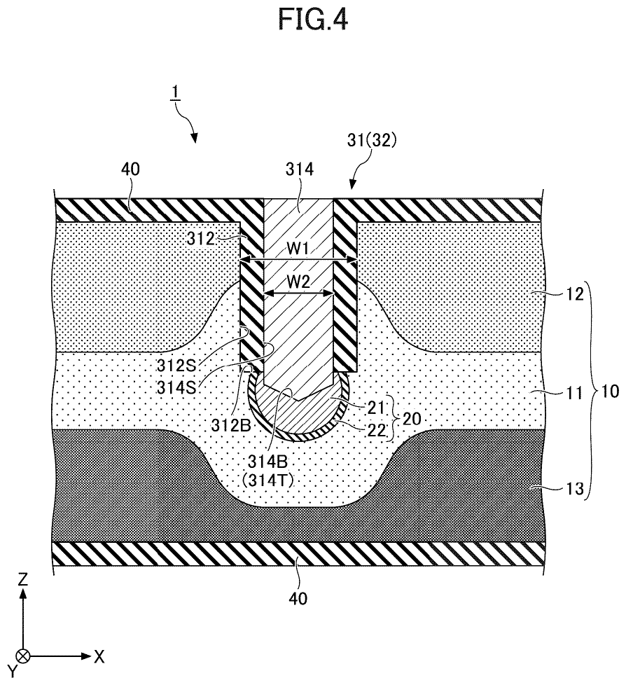

Next, the structure of the terminal pair 30 will be described with reference to FIGS. 4 and 5. FIG. 4 is a cross-sectional view of the first terminal part 31 included in the terminal pair 30. FIG. 5 is a plan view of the first terminal part 31 included in the terminal pair 30. Since the cross-sectional structure and the plan structure of the second terminal part 32 are the same, description thereof will be omitted.

As shown in FIG. 4, the first terminal part 31 has an insulating first protrusion 312 and a conductive second protrusion 314. In the first embodiment, the outermost part of the first protrusion 312 contacts the first magnetic layer 11 of the magnetic laminate 10. That is, the first protrusion 312 is disposed at the outermost part of the first terminal part 31. Since an insulating portion such as the first protrusion 312 is disposed outermost of the first terminal part 31, a short circuit between the magnetic laminate 10 and the second protrusion 314 can be prevented. The second protrusion 314 may be referred to as a “conductive protrusion”.

The first protrusion 312 is a cylindrical insulating portion extending from the front surface 10S of the magnetic laminate 10 toward the back surface 10B. The planar shape of the first protrusion 312 is approximately circular. However, the cross-sectional and planar shapes of the first protrusion 312 are not limited thereto.

As shown in FIG. 4, the first protrusion 312 may be connected to, for example, the insulating film 40 covering the front surface 10S of the magnetic laminate 10. When connected to the insulating film 40, the first protrusion 312 may be made of the same insulating material as the insulating film 40, but not limited thereto. However, the first protrusion 312 may also be made of different insulating materials from the insulating film 40. Materials of the first protrusion 312 are not particularly limited, but as an example, a resin such as an epoxy may be used.

A bottom surface 312B of the first protrusion 312 reaches inside the conducting core 21 of the interconnect 20. That is, the bottom surface 312B of the first protrusion 312 crosses the conducting core 21 of the interconnect 20. The bottom surface 312B of the first protrusion 312 may be flat or may have a tapered part having a width that decreases downward. Further, a maximum width W1 of the first protrusion 312 is wider than a diameter W2 of the interconnect 20.

In the first terminal part 31, the second protrusion 314 corresponds to a current path through which a current flows from an external current source to the interconnect 20. More specifically, the second protrusion 314 is a conductive rod-shaped portion disposed inside the first protrusion 312 and penetrating the first protrusion 312. As shown in FIG. 4, the second protrusion 314 preferably extends along the Z-direction. A lateral surface 314S of the second protrusion 314 is preferably parallel to a lateral surface 312S of the first protrusion 312. Examples of materials of the second protrusion 314 include metal conductors such as copper, silver, gold, aluminum, nickel, and alloys thereof, but are not limited thereto. The planar shape of the second protrusion 314 is approximately circular. However, the cross-sectional and planar shape of the second protrusion 314 are not limited thereto.

A bottom surface 314B of the second protrusion 314 reaches inside the conducting core 21 of the interconnect 20. The bottom surface 314B of the second protrusion 314 is deeper than the bottom surface 312B of the first protrusion 312. The bottom surface 314B of the second protrusion 314 may have a tapered part 314T having a width that decreases downward. Thus, a contact area between the second protrusion 314 and the conducting core 21 of the interconnect 20 can be increased. As a result, resistance at an interface between the second protrusion 314 and the conducting core 21 can be reduced.

Each of the first terminal parts 31 (second terminal parts 32) of the plurality of terminal pairs 30 has a second protrusion 314. The horizontal cross-sectional area of each of the second protrusions 314, that is, the cross-sectional area taken along a plane perpendicular to the extension direction of the second protrusion 314 (plane along the in-plane direction), may be identical or different.

For example, as in the case of the first terminal part 31a of the terminal pair 30a connected to the interconnect 20a and the second terminal part 32b of the terminal pair 30b connected to the interconnect 20b, it is preferable that the contact area between the second protrusion 314 in the single terminal part, which functions as a common terminal for the interconnects 20 collinear along the Y direction, and the conducting core 21 of the interconnect 20 (e.g., interconnects 20a, 20b) is larger than the contact area between the second s protrusion 314 of a terminal part different from the single terminal part and the conducting core 21 of the interconnect 20. In the case of the second protrusion 314 shown in FIG. 4, the contact area of the interconnect 20 with the conducting core 21 corresponds to the sum of the area of the bottom surface 314B of the second protrusion 314 and the area of the lateral surface 314S of the second protrusion 314 located at the bottom of the bottom surface 312B of the first protrusion 312.

Thus, the maximum allowable current of the single terminal part can be increased. As a result, even if the interconnects 20 collinear along the Y-direction are connected to each other, the current value which can be supplied to both interconnects 20 at the same time can be prevented from being reduced.

### <<Modification of Terminal Pair>>

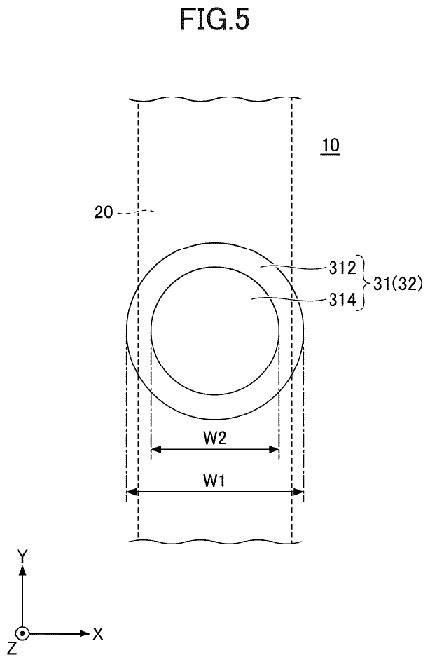

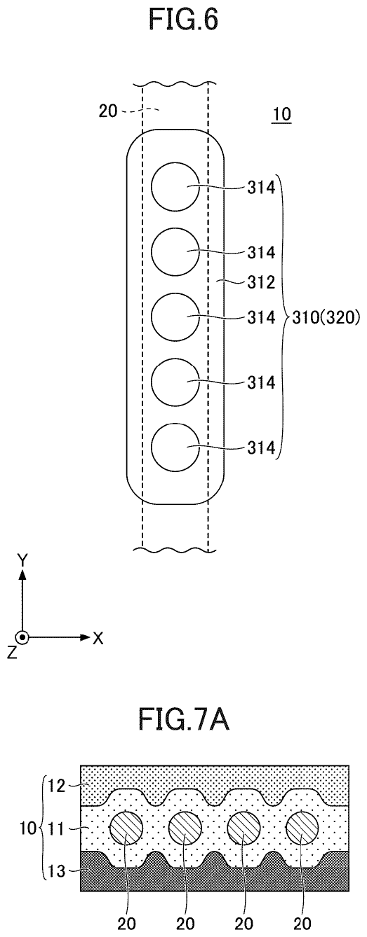

Next, modifications of the first terminal part 31 and the second terminal part 32 of the terminal pair 30 will be described with reference to FIG. 6. FIG. 6 is a plan view of the first terminal part 310 or the second terminal part 320 according to the modification. As shown in FIG. 6, the planar shape of the first protrusion 312 is elongated in the Y-direction. A plurality of second protrusions 314 are formed inside the first protrusion 312. All of the plurality of second protrusions 314 are connected to the conducting core 21 of one interconnect 20. The number of the second protrusions 314 shown in the figure is five, but is not limited thereto.

Thus, the contact area of the interconnect 20 with the conducting core 21 can be increased by forming the plurality of second protrusions 314 in each first terminal part 310 or each second terminal part 320. As a result, the electric resistance of each first terminal part 310 or each second terminal part 320 can be reduced. In addition, an amount of current supplied from the second protrusions 314 to the conducting core 21 can be increased.

That is, according to the first terminal part 310 or the second terminal part 320 according to the modification, a terminal part having a high maximum allowable current can be formed. Therefore, the first terminal part 310 or the second terminal part 320 according to the modification is suitable for a single terminal part which functions as a common terminal between the interconnects 20 collinear along the Y-direction.

### <Method for Manufacturing Inductor Member>

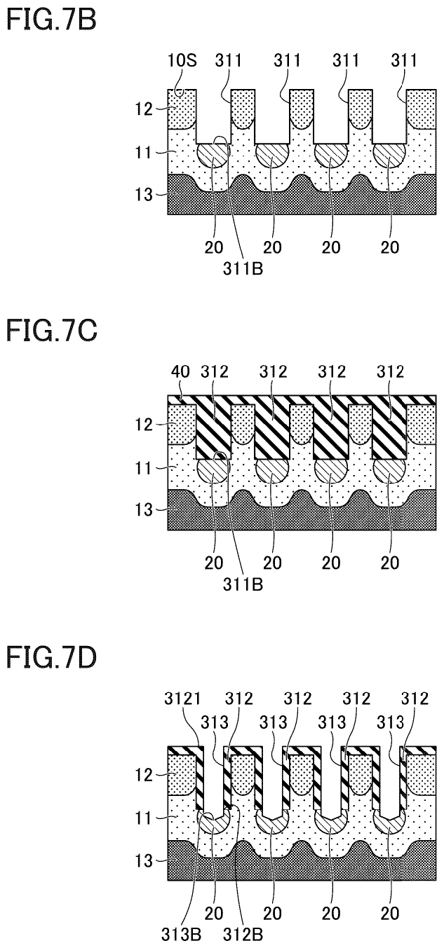

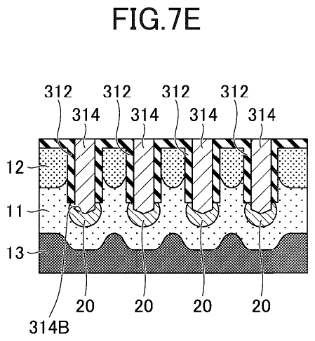

Next, a method for manufacturing the inductor member 1 according to the first embodiment will be described with reference to FIGS. 7A to 7E. Each of FIGS. 7A to 7E is a schematic diagram illustrating an example of a method of manufacturing the inductor member 1 according to the first embodiment.

As shown in FIG. 7A, first, a plurality of interconnects 20 are embedded inside the magnetic laminate 10. Thus, a magnetic structure including the magnetic laminate 10 and interconnects 20 is produced. More specifically, after stacking the third magnetic layer 13, the first magnetic layer 11 including the interconnects 20, and the second magnetic layer 12 in sequence from the other side in the Z-direction toward the one side in the Z-direction, the stacked magnetic layers are pressed using a pressurizing equipment such an isotropic pressurizer. A method for manufacturing the magnetic structure is not limited thereto. A process for manufacturing the magnetic structure may be referred to as a “first process”.

Subsequently, as shown in FIG. 7B, first holes 311 are recessed from the front surface of the magnetic structure, that is, the front surface 10S of the magnetic laminate 10, toward the back surface 10B. The number of the first holes 311 corresponds to the number of the first terminal parts 31 and the second terminal parts 32 of the terminal pairs 30. The first holes 311 shown in the figure are all formed on the front surface 10S of the magnetic laminate 10, but are not limited thereto.

The first hole 311 is preferably formed with a cutting tool such as a router end mill or a drill. Hereinafter, a method using a router end mill may be referred to as a “routing method”. A method using a drill may be referred to as a “drilling method”. However, the first hole 311 may be formed with other methods.

As shown in FIG. 7B, the bottom surface 311B of the first hole 311 reaches the conducting core 21 of the interconnect 20. Furthermore, the diameter of the first hole 311 is larger than the diameter of the interconnect 20. Thus, the entire width of the interconnect 20 can be exposed. The process of forming the first hole 311 may be referred to as a “second process”. When the conducting core 21 positioned between respective interconnects 20 is cut in order to achieve the arrangement of the interconnects 20 as shown in FIG. 1, such as the interconnect 20e and the interconnect 20f, and the interconnect 20g and the interconnect 20h, it is preferable to perform cutting process on the conducting core 21 at this process. In this case, both of the interconnect 20e and the interconnect 20f, and the interconnect 20g and the interconnect 20h are electrically separated from each other by cutting approximately the entirety of the conducting core 21 with the same processing equipment as in the case of forming the first hole 311.

Subsequently, as shown in FIG. 7C, an insulating film is filled inside the first hole 311 to form the first protrusion 312. More specifically, an insulating film including the region of the first protrusion 312 is laminated on the front surface 10S of the magnetic laminate 10. The laminated insulating film may include the region of the insulating film 40 connected to the first protrusion 312 in addition to the first protrusion 312. However, the method of forming the first protrusion 312 is not limited thereto. The process of forming the first protrusion 312 may be referred to as a “third process”. In FIG. 1, when a cut portion is formed between both the interconnect 20e and the interconnect 20f, and between both the interconnect 20g and the interconnect 20h, the cut portion is also filled with the insulating film.

Subsequently, as shown in FIG. 7D, the second hole 313 is formed from the surface 3121 located on one side of the first protrusion 312 in the Z-direction toward the other side in the Z-direction. The method of forming the second hole 313 is not particularly limited, but is preferably a drilling method.

The bottom surface 313B of the second hole 313 reaches the interconnect 20 and is deeper than the bottom surface 312B of the first protrusion 312. That is, the second hole 313 penetrates the first protrusion 312 in the thickness direction. When the first hole 311 is formed, the entire width of the interconnect 20 is exposed from the first hole 311. Therefore, the second hole 313 in a state where all of the bottom surface 313B is contained within the interconnect 20 can be easily formed. A process of forming the second hole 313 may be referred to as a “fourth process”.

Subsequently, as shown in FIG. 7E, the second hole 313 is filled with a conductor. Thus, a conductive second protrusion 314 for supplying a current to the interconnect 20 from an external current source is formed. The method of filling the conductor forming the second protrusion 314 is not particularly limited, but an electrolytic plating method, an electroless plating method, and the like are exemplified. A process of forming the second protrusion 314 may be referred to as a “fifth process”. Thus, the first terminal part 31 and the second terminal part 32 of the terminal pair 30 are formed.

The inductor member 1 can be manufactured through these first to fifth processes.

### Second Embodiment

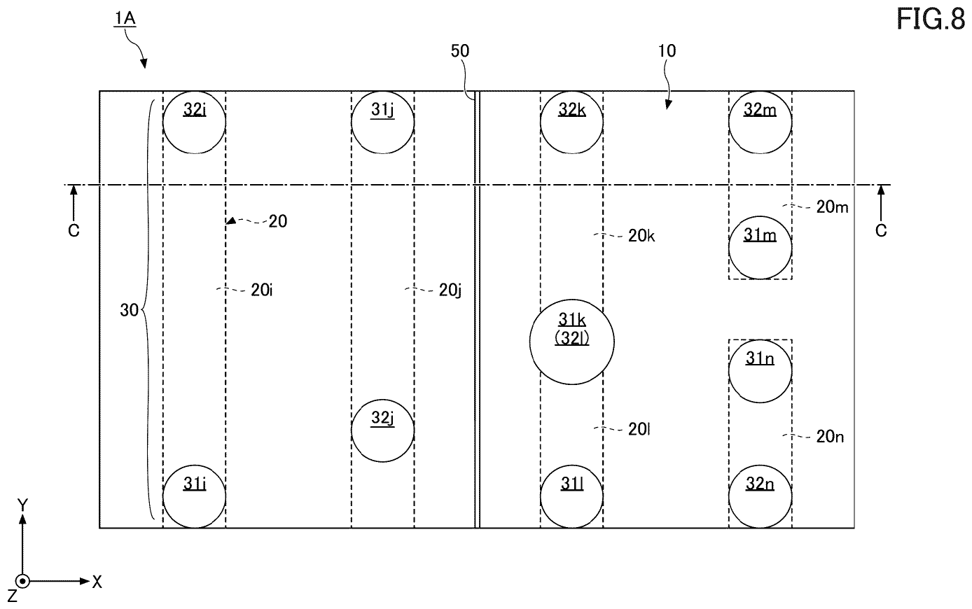

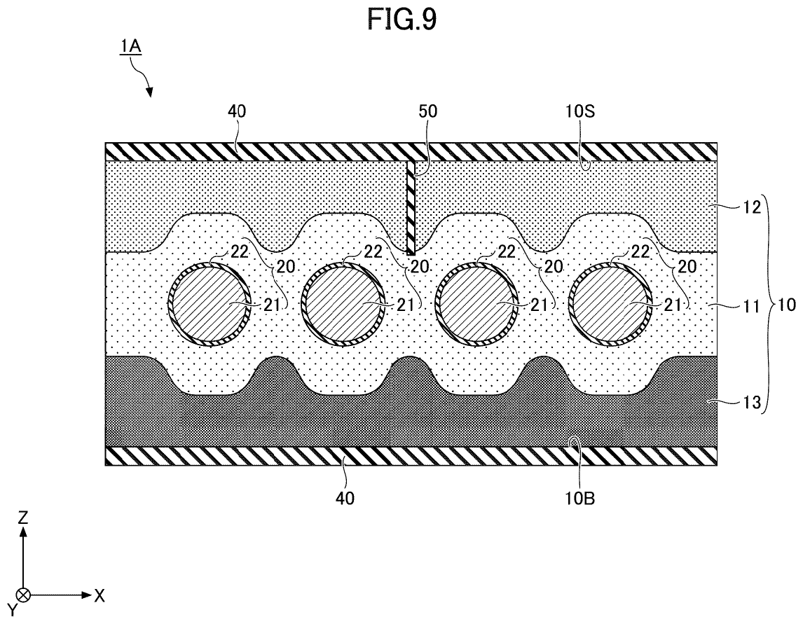

Next, an inductor member 1A according to a second embodiment will be described with reference to FIGS. 8 and 9. FIG. 8 is a plan view of the inductor member 1A. FIG. 9 is a C-C cross-sectional view of FIG. 8. Note that, the same name and reference numerals as in the first embodiment refer to the same or corresponding constituent elements, and redundant description thereabout may be omitted.

As shown in FIGS. 8 and 9, the inductor member 1A includes a magnetic laminate 10, a plurality of interconnects 20, terminal pairs 30 electrically connected to the interconnects 20, and an insulating film 40 covering the front surface 10S and the back surface 10B of the magnetic laminate 10. The magnetic laminate 10 is a laminate composed of the first magnetic layer 11, the second magnetic layer 12, and the third magnetic layer 13; however, as in the first embodiment, it may alternatively be a single-layer structure composed solely of the first magnetic layer 11. The insulating film 40 may be provided as needed.

The interconnect 20 extends in the Y-direction. In addition, at least two interconnects 20 of the plurality of interconnects 20 are arranged at different positions in the X-direction. For example, the interconnects 20i and 20j are arranged at different positions in the X-direction. The interconnects 20 arranged at different positions in the X-direction are parallel to each other. Thus, the interconnects 20 can be arranged compactly, and the inductor member 1 can be miniaturized. However, the interconnects 20 arranged in the X-direction may be arranged at equal intervals or at different intervals.

A slit 50 extending in the Y-direction may be disposed between the interconnects 20 that are adjacent to each other in the X-direction. In the case of FIG. 8, a slit 50 is disposed between the interconnect 20j and the interconnect 20k (interconnect 201). By providing the slit 50 between the interconnects 20 adjacent to each other in the X-direction, crosstalk between the interconnects 20 can be prevented when current flows to each of the adjacent interconnects 20. However, the number and positions of the slits 50 are not limited to this, but when the magnetic particles of the first magnetic layer 11 have an isotropic shape, such as an approximately spherical shape, and the magnetic particles of the second magnetic layer 12 and the third magnetic layer 13 have an anisotropic shape, such as an approximately flat shape, it is desirable for the slit 50 to be formed so as to reach the first magnetic layer 11 from the front surface 10S of the magnetic laminate 10.

As in the first embodiment, the inductance value H of each of the plurality of interconnects 20 varies according to the length of each f the interconnects 20. Here, the length of the interconnect 20i is longer than that of the interconnect 20j adjacent to the interconnect 20i in the X-direction. Therefore, the inductance value H9 corresponding to the length of the interconnect 20i is larger than that of the inductance value H10 corresponding to the length of the interconnect 20j.

The inductor member 1A may have interconnects 20 collinear along the Y-direction, such as interconnects 20k and 20l. Further, two or more interconnects 20 collinear along the Y-direction, such as interconnects 20k and 20l, may be connected to each other. In this case, the first terminal part 31k connected to the interconnect 20k and the second terminal part 321 connected to the interconnect 20l form a single terminal part.

The number of interconnects 20 collinear along the Y-direction is not limited to two, and may be three or more. The interconnect 20k shown in the figure is longer than the interconnect 20l, but the lengths of the two or more interconnects 20 collinear along the Y-direction may be substantially the same. Furthermore, the two or more interconnects 20 collinear along the Y-direction may be spaced apart, such as the interconnect 20m and the interconnect 20n.

The method of forming the two physically separated interconnects 20 is not particularly limited, but for example, the magnetic laminate 10 is shaved from the front surface 10S of the magnetic laminate 10 using a cutting tool, and the conductor interconnects originally in a series are broken. Thus, the two interconnects 20 may be formed. The insulating film 40 may be filled between the two physically Separated interconnects 20.

In this way, the plurality of interconnects 20 can be collinear along the Y-direction. Thus, the plurality of interconnects 20 can be compactly arranged in the inductor member 1, and the inductor member 1 can be miniaturized.

The inductance values H of the plurality of interconnects 20 can be adjusted by changing the length of the interconnects 20. Therefore, the interconnects 20 having a desired inductance value H among the plurality of interconnects 20 can be suitably included in the circuit connected to the inductor member 1A. Moreover, even if the circuit including the inductor member 1 is designed to include a plurality of inductors, the circuit can include a plurality of interconnects 20 having an inductance value H suitable for each inductor. As a result, according to the inductor member 1A, the degree of freedom in the design of the connected circuit can be increased.

### Third Embodiment

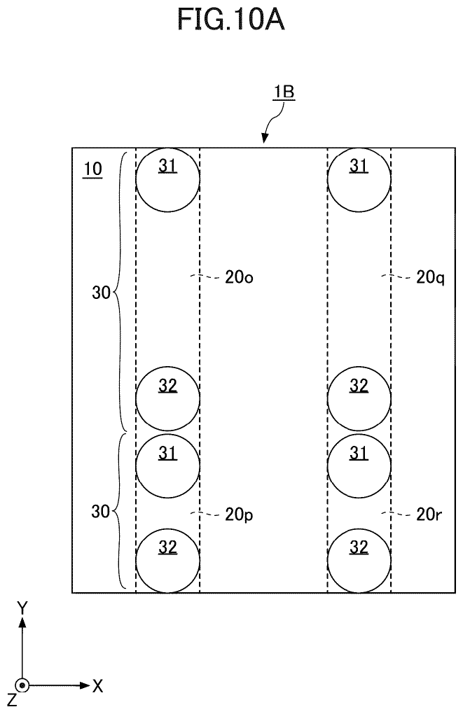

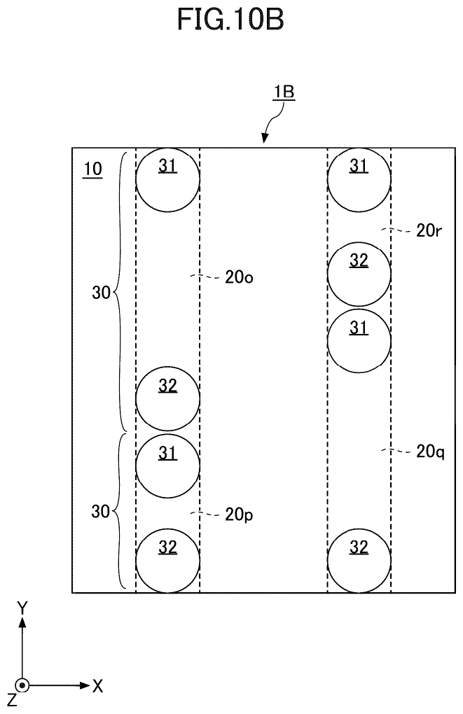

Next, an inductor member 1B according to the third embodiment will be described with reference to FIGS. 10A and 10B. FIGS. 10A and 10B are plan views of the inductor member 1B. With respect to the third embodiment, the same name and reference numerals as in the first and second embodiments refer to the same or corresponding constituent elements, and redundant description thereabout may be omitted.

As in the first embodiment and the second embodiment, the inductor member 1B according to the third embodiment has a magnetic laminate 10, a plurality of interconnects 20, and terminal pairs 30 electrically connected to respective interconnects 20.

Specifically, as shown in FIGS. 10A and 10B, four interconnects 20o, 20p, 20q, and 20r extending in the Y-direction are provided as the interconnects 20. However, the number of interconnects 20 is not limited thereto.

As in the first embodiment and the second embodiment, the inductance values H of the interconnects 20 vary according to the lengths of the interconnects 20. The length of the interconnect 200 is equal to the length of the interconnect 20q. Therefore, the inductance values H of the interconnect 20o and the interconnect 20q are equal. The length of the interconnect 20p is equal to the length of the interconnect 20r. Therefore, the inductance values H of the interconnect 20p and the interconnect 20r are equal. However, this is not limited to this, and the lengths of the interconnects 20 may be different from each other. In other words, the inductance values H of the interconnects 20 may be different from each other. The term “equal” with respect to the lengths and inductance values H of the interconnects 20 includes not only exact equality but also slight differences that are regarded as substantially equal.

The interconnect 20o and the interconnect 20p are aligned in the Y-direction. A group of the interconnect 20 including the interconnect 20o and the interconnect 20p may be referred to as a “first interconnect group”. The interconnect 20o is an example of the “first interconnect”. The interconnect 20p is an example of the “second interconnect”. Although not shown in FIGS. 10A and 10B, if the interconnect 20o and the interconnect 20p are provided with another interconnect 20 collinear along the Y-direction, the other interconnect 20 is included in the first interconnect group.

The interconnect 20q and the interconnect 20r are collinear along the Y-direction. The group of interconnect 20 including the interconnect 20q and the interconnect 20r may be referred to as the “second interconnect group”. The interconnect 20q is an example of the “third interconnect”. The interconnect 20r is an example of the “fourth interconnect”. Although not shown in FIGS. 10A and 10B, if the interconnect 20q and the interconnect 20r are further provided with another interconnect 20 collinear along the Y-direction, the other interconnect 20 is included in the second interconnect group.

As shown in FIGS. 10A and 10B, the interconnect 20 (e.g., interconnects 20o, 20p) included in the first interconnect group and the interconnect 20 (e.g., interconnects 20q, 20r) included in the second interconnect group are arranged at different positions in the X-direction. Here, in the first interconnect group, as shown in FIG. 10A, the interconnect 20o may be arranged on one side in the Y-direction (upper part in the figure) and the interconnect 20p may be arranged on the other side in the Y-direction (lower part in the figure). In the second interconnect group, as shown in FIG. 10A, the interconnect 20q may be arranged on one side in the Y-direction (upper part in the figure) and the interconnect 20r may be arranged on the other side in the Y-direction (lower part in the figure). That is, the interconnect 20o of the first interconnect group and the interconnect 20q of the second interconnect group having the same length as the interconnect 200 are positioned opposite each other in the X-direction. In addition, the interconnect 20p of the first interconnect group and the interconnect 20r of the second interconnect group having the same length as the interconnect 20p are positioned opposite each other in the X-direction.

Unlike this layout, in the second interconnect group, as shown in FIG. 10B, the interconnect 20q may be arranged on the other side in the Y-direction (lower part in the figure) and the interconnect 20r may be arranged on the one side in the Y-direction (upper part in the figure). That is, the interconnect 20o of the first interconnect group and the interconnect 20r of the second interconnect group having a different length than the interconnect 20o are positioned opposite each other in the X-direction. In addition, the interconnect 20p of the first interconnect group and the interconnect 20q of the second interconnect group having a different length than the interconnect 20p are positioned opposite each other in the X-direction.

Thus, each of the first interconnect group and the second interconnect group includes one pair (e.g., a pair of interconnects 20o and 20q, and a pair of interconnects 20p and 20r) of interconnects 20 having the same length, so that the first interconnect group and the second interconnect group having the same total inductance value can be arranged at different positions in the X-direction. Thus, as shown in FIGS. 10A and 10B, by appropriately changing the positional relationship of the pairs o f interconnects 20 having the same length, the layout of the plurality of interconnects 20 can be appropriately adjusted according to the structure of the circuit electrically connected to the inductor member 1B.

Moreover, since the first interconnect group including the interconnects 20o and 20p aligned in the Y-direction and the second interconnect group including the interconnects 20q and 20r aligned in the Y-direction are arranged at different positions in the X-direction, the plurality of interconnects 20 can be arranged compactly. As a result, the inductor member 1B can be miniaturized.

Although the interconnects 20o and 20p shown in FIGS. 10A and 10B share a continuous conductor (e.g., conducting core 21 shown in FIGS. 3 and 9) extending in the Y-direction, the conductor may not be continuous between the interconnects 20o and 20p. When the interconnects 20o and 20p share a continuous conductor extending in the Y-direction, the first terminal part 31 (or the second terminal part 32) of the terminal pair 30 electrically connected to the interconnect 20o and the first terminal part 31 (or the second terminal part 32) of the terminal pair 30 electrically connected to the interconnect 20p may form a single terminal part.

Although the interconnects 20q and 20r shown in FIGS. 10A and 10B share a continuous conductor (e.g., conducting core 21 shown in FIGS. 3 and 9) extending in the Y-direction, the conductor may not be continuous between the interconnects 20qand 20r. When the interconnect 20q and the interconnect 20r share a continuous conductor extending in the Y-direction, the first terminal part 31 (or the second terminal part 32) of the terminal pair 30 electrically connected to the interconnect 20q and the first terminal part 31 (or the second terminal part 32) of the terminal pair 30 electrically connected to the interconnect 20r may form a single terminal part.

Clauses of the present disclosure are as follows.
<1> An inductor member including:
   a magnetic layer;
   a plurality of interconnects disposed inside the magnetic layer and extending in a first direction; and
   a plurality of terminal pairs each including a first terminal part and a second terminal part, wherein:
   at least two interconnects of the plurality of interconnects are collinear along the first direction; and
   each of the at least two interconnects is connected to a corresponding pair of the plurality of terminal pairs.
<2> The inductor member according to <1>, wherein:
   the at least two interconnects are connected to each other; and
   the first terminal part connected to one of the at least two interconnects and the second terminal part connected to another one of the at least two interconnects form a single terminal part.
<3> The inductor member according to <2>, wherein:
   each of the first terminal part and the second terminal part includes a protrusion of conductive property extending toward a corresponding interconnect of the plurality of interconnects; and
   a contact area at a connection between the protrusion of conductive property of a terminal part, among the first terminal part and the second terminal part, corresponding to the single terminal part and the corresponding interconnect of the plurality of interconnects is larger than a contact area at a connection between a terminal part different from the single terminal part and the corresponding interconnect of the plurality of interconnects.
<4> The inductor member according to <1>, wherein the at least two interconnects are spaced apart.
<5> The inductor member according to any one of <1> to <4>, wherein the at least two interconnects have lengths different from each other.
<6> The inductor member according to <5>, wherein each of the at least two interconnects has an inductance value determined by a length thereof.
<7> The inductor member according to any one of <1> to <6>, wherein the plurality of interconnects include another interconnect disposed at a position different from the at least two interconnects in a second direction different from the first direction.
<8> The inductor member according to any one of <1> to <7>, wherein:
   the magnetic layer includes:
      a first surface on one side in a thickness direction; and
      a second surface on another side in the thickness direction;
   each of the plurality of interconnects has:
      a conducting core; and
      an insulating film covering a peripheral surface of the conducting core;
   at least one of the first terminal part and the second terminal part of each of the plurality of terminal pairs includes:
      a first protrusion of insulating property extending from either the first surface or the second surface of the magnetic layer toward an opposite surface; and
      a second protrusion of conductive property being disposed inside the £ first protrusion and penetrating the first protrusion;
   a bottom surface of the first protrusion reaches the conducting core of a corresponding interconnect of the plurality of interconnects; and
   a bottom surface of the second protrusion is deeper than the bottom surface of the first protrusion.
<9> The inductor member according to <8>, wherein:
   the at least two interconnects are connected to each other;
   the first terminal part connected to one of the at least two interconnects and the second terminal part connected to another one of the at least two interconnects form a single terminal part; and
   a contact area between the second protrusion of a terminal part, among the first terminal part and the second terminal part, corresponding to the single terminal part and the corresponding interconnect of the plurality of interconnects is larger than a contact area between the second protrusion of a terminal part different from the single terminal part and the corresponding interconnect of the plurality of interconnects.
<10> The inductor member according to <8> or <9 >, including a plurality of said second protrusions formed inside the first protrusion.
<11> The inductor member according to any one of <8> to <10>, wherein a lateral surface of the first protrusion and a lateral surface of the second protrusion are parallel to each other.
<12> The inductor member according to any one of <8> to <11>, wherein the bottom surface of the first protrusion is flat.
<13> The inductor member according to any one of <8> to <11>, wherein the bottom surface of the first protrusion includes a tapered part having a width that decreases downward.
<14> The inductor member according to any one of <8> to <13>, wherein the bottom surface of the second protrusion includes a tapered part having a width that decreases downward.
<15> An inductor member including:
   a magnetic layer;
   a plurality of interconnects disposed inside the magnetic layer and extending in a first direction; and
   a plurality of terminal pairs each including a first terminal part and a second terminal part, wherein:
   at least two interconnects of the plurality of interconnects are disposed at different positions in a second direction different from the first direction;
   each of the at least two interconnects is connected to a corresponding pair of the plurality of terminal pairs; and
   the at least two interconnects have different lengths.
<16> The inductor member according to <15>, wherein each of the at least two interconnects has an inductance value corresponding to a length thereof.
<17> The inductor member according to <15> or <16>, wherein one or two of the at least two interconnects are collinear along the first direction with one or more interconnects other than the at least two interconnects.
<18> The inductor member according to <17>, wherein the two of the at least two interconnects are collinear along the first direction with the interconnects other than the at least two interconnects.
<19> The inductor member according to <18>, wherein interconnects of the plurality of interconnects that are positioned opposite each other in the second direction have a same length.
<20> The inductor member according to <18>, wherein interconnects of the plurality of interconnects that are positioned opposite each other in the second direction have different lengths.
<21> The inductor member according to any one of <15> to <20>, wherein the magnetic layer includes a slit positioned between the at least two interconnects.
<22> The inductor member according to any one of <15> to <21>, wherein:
   the magnetic layer includes:
      a first surface on one side in a thickness direction; and
      a second surface on another side in the thickness direction;
   each of the plurality of interconnects has:
      a conducting core; and
      an insulating film covering a peripheral surface of the conducting core;
   at least one of the first terminal part and the second terminal part of each of the terminal pairs includes:
      a first protrusion of insulating property extending from either the first surface or the second surface of the magnetic layer toward an opposite surface; and
      a second protrusion of conductive property being disposed inside the first protrusion and penetrating the first protrusion;
   a bottom surface of the first protrusion reaches the conducting core of a corresponding interconnect of the plurality of interconnects; and
   a bottom surface of the second protrusion is deeper than the bottom surface of the first protrusion.

The present application is based on and claims priority to Japanese patent application No. 2023-045791 filed on Mar. 22, 2023, with the Japan Patent Office, the entire contents of which are hereby incorporated by reference.

### REFERENCE SIGNS LIST

1 inductor member
10 magnetic laminate
10S front surface of magnetic laminate
10B back surface of magnetic laminate
11 first magnetic layer
12 Second magnetic layer
13 third magnetic layer
20 interconnect
21 conducting core of interconnect
22 insulating film covering conducting core
30 terminal pair
31, 310 first terminal part
32, 320 second terminal part
311 first hole
312 first protrusion
313 second hole
314 second protrusion (conductive protrusion)
40 insulating film
50 slit

1. An inductor member comprising:
a magnetic layer;
a plurality of interconnects disposed inside the magnetic layer and extending in a first direction; and
a plurality of terminal pairs each including a first terminal part and a second terminal part, wherein:
at least two interconnects of the plurality of interconnects are collinear along the first direction; and
each of the at least two interconnects is connected to a corresponding pair of the plurality of terminal pairs.

2. The inductor member according to claim 1, wherein:
the at least two interconnects are connected to each other; and
the first terminal part connected to one of the at least two interconnects and the second terminal part connected to another one of the at least two interconnects form a single terminal part.

3. The inductor member according to claim 2, wherein:
each of the first terminal part and the second terminal part includes a protrusion of conductive property extending toward a corresponding interconnect of the plurality of interconnects; and
a contact area at a connection between the protrusion of conductive property of a terminal part, among the first terminal part and the second terminal part, corresponding to the single terminal part and the corresponding interconnect of the plurality of interconnects is larger than a contact area at a connection between a terminal part different from the single terminal part and the corresponding interconnect of the plurality of interconnects.

4. The inductor member according to claim 1, wherein the at least two interconnects are spaced apart.

5. The inductor member according to claim 1, wherein the at least two interconnects have lengths different from each other.

6. The inductor member according to claim 5, wherein each of the at least two interconnects has an inductance value determined by a length thereof.

7. The inductor member according to claim 1, wherein the plurality of interconnects include another interconnect disposed at a position different from the at least two interconnects in a second direction different from the first direction.

8. The inductor member according to claim 1, wherein:
the magnetic layer includes:
a first surface on one side in a thickness direction; and
a second surface on another side in the thickness direction;
each of the plurality of interconnects has:
a conducting core; and
an insulating film covering a peripheral surface of the conducting core;
at least one of the first terminal part and the second terminal part of each of the plurality of terminal pairs includes:
a first protrusion of insulating property extending from either the first surface or the second surface of the magnetic layer toward an opposite surface; and
a second protrusion of conductive property being disposed inside the first protrusion and penetrating the first protrusion;
a bottom surface of the first protrusion reaches the conducting core of a corresponding interconnect of the plurality of interconnects; and
a bottom surface of the second protrusion is deeper than the bottom surface of the first protrusion.

9. The inductor member according to claim 8, wherein:
the at least two interconnects are connected to each other;
the first terminal part connected to one of the at least two interconnects and the second terminal part connected to another one of the at least two interconnects form a single terminal part; and
a contact area between the second protrusion of a terminal part, among the first terminal part and the second terminal part, corresponding to the single terminal part and the corresponding interconnect of the plurality of interconnects is larger than a contact area between the second protrusion of a terminal part different from the single terminal part and the corresponding interconnect of the plurality of interconnects.

10. The inductor member according to claim 8, comprising a plurality of said second protrusions formed inside the first protrusion.

11. The inductor member according to claim 8, wherein a lateral surface of the first protrusion and a lateral surface of the second protrusion are parallel to each other.

12. The inductor member according to claim 8, wherein the bottom surface of the first protrusion is flat.

13. The inductor member according to claim 8, wherein the bottom surface of the first protrusion includes a tapered part having a width that decreases downward.

14. The inductor member according to claim 8, wherein the bottom surface of the second protrusion includes a tapered part having a width that decreases downward.

15. An inductor member comprising:
a magnetic layer;
a plurality of interconnects disposed inside the magnetic layer and extending in a first direction; and
a plurality of terminal pairs each including a first terminal part and a second terminal part, wherein:
at least two interconnects of the plurality of interconnects are disposed at different positions in a second direction different from the first direction;
each of the at least two interconnects is connected to a corresponding pair of the plurality of terminal pairs; and
the at least two interconnects have different lengths.

16. The inductor member according to claim 15, wherein each of the at least two interconnects has an inductance value corresponding to a length thereof.

17. The inductor member according to claim 15, wherein one or two of the at least two interconnects are collinear along the first direction with one or more interconnects other than the at least two interconnects.

18. The inductor member according to claim 17, wherein the two of the at least two interconnects are collinear along the first direction with the interconnects other than the at least two interconnects.

19. The inductor member according to claim 18, wherein interconnects of the plurality of interconnects that are positioned opposite each other in the second direction have a same length.

20. The inductor member according to claim 18, wherein interconnects of the plurality of interconnects that are positioned opposite each other in the second direction have different lengths.

21. The inductor member according to claim 15, wherein the magnetic layer includes a slit positioned between the at least two interconnects.

22. The inductor member according to claim 15, wherein:
the magnetic layer includes:
a first surface on one side in a thickness direction; and
a second surface on another side in the thickness direction;
each of the plurality of interconnects has:
a conducting core; and
an insulating film covering a peripheral surface of the conducting core;
at least one of the first terminal part and the second terminal part of each of the terminal pairs includes:
a first protrusion of insulating property extending from either the first surface or the second surface of the magnetic layer toward an opposite surface; and
a second protrusion of conductive property being disposed inside the first protrusion and penetrating the first protrusion;
a bottom surface of the first protrusion reaches the conducting core of a corresponding interconnect of the plurality of interconnects; and
a bottom surface of the second protrusion is deeper than the bottom surface of the first protrusion.
